(19) United States
(12) Patent Application Publication
(10) Pub. No.: US 2004/0070630 A1
(43) Pub. Date: Apr. 15, 2004

(54) Multifunction apparatus, server, and server system

(75) Inventors: Koichi Nagoshi, Kanagawa (JP); Takayuki Fukushima, Tokyo (JP); Ikuo Yoshida, Kanagawa (JP); Takeshi Ootsuka, Kanagawa (JP); Kiyohiko Honda, Tokyo (JP)

Correspondence Address: GREENBLUM & BERNSTEIN, P.L.C., 1950 ROLAND CLARKE PLACE, RESTON, VA, 20191, US

(73) Assignee: Panasonic Communications Co., Ltd., Tokyo (JP)

(21) Appl. No.: 10/663,688

(22) Filed: Sep. 17, 2003

(30) Foreign Application Priority Data
Sep. 26, 2002 (JP) 2002-281283

(51) Int. Cl. G09G 5/00

(52) U.S. Cl. 345/810

(57) ABSTRACT

In a distribution server of a distribution server system according to the present invention, menu information, including a menu item name and information to execute a job related to the menu item name, is generated based on display capability information and job capability information of each multifunction apparatus. The generated menu information is stored in a hard disk. When the multifunction apparatus requests for the menu information, the distribution server retrieves the information from the hard disk and delivers the same to the requesting multifunction apparatus via a network. The display capability information and job capability information of the multifunction apparatus is displayed so that personalized menu information can be generated, by a user, based on a menu item name (set within the range of the display capability) and a function (selected from the job capability).

### BACKGROUND OF THE INVENTION

1. Field of the Invention

The present invention relates to a multifunction apparatus that receives and utilizes a menu information necessary for its operation via network, a server that distributes the menu information to the multifunction apparatus, a server system consists of the multifunction apparatus and the server and a method for controlling the multifunction apparatus.

2. Description of Related Art

Recent multifunction apparatuses have been obtaining an address book from a server so as to distribute scanned data to a terminal (PC) via a network. In order to distribute the scanned data, the server generates an address book that defines each terminal and document management server. The address book is obtained when a multifunction apparatus presses an address book obtaining key displayed on a panel. By selecting from the address book, the desired address to distribute the scanned data can be obtained. Then, the document is scanned and the scanned data is transmitted to the selected address of the distribution destination via the server.

An apparatus that can register a menu has been disclosed (e.g., Related Art 1). This apparatus provides a special menu screen that minimizes a number of operations for reaching a desired menu item, and stores the menu screen inside of the user's apparatus.

### RELATED ART

Japanese Patent Laid Open Publication H9-54668 (Paragraph 0018, FIG. 1)

However, with the configuration of the above-described conventional technology, the address book (specifying the address for distributing the scanned data and/or for forwarding the received facsimile data) cannot be used as a menu to display all type of functions that the multifunction apparatus possesses. This is because the multifunction apparatus displays an address book for distributing a scanned data and an address book for transferring a receiving data, on different menus.

Further, since an operation of a particular user cannot be personalized and displayed on the multifunction apparatus, a necessary menu item needs to be found from the common menu.

In addition, there are some multifunction apparatuses that are not equipped with a facsimile function. However, it is complicated that such a multifunction apparatus requests a fax transmission to another multifunction apparatus that is equipped with the function.

Furthermore, an additional storage memory is required, even if a multifunction apparatus stores each user's individual information.

### SUMMARY OF THE INVENTION

This invention is provided to address the above-described problems. The purpose of the invention is to provide a multifunction apparatus, a server, and a server system that have the menu that is commonly utilized for any other multifunction apparatus, displayed on the panel of the multifunction apparatus.

Another purpose of the invention is to provide a multifunction apparatus, a server, and a server system that make it easier to request a execution of a function from one multifunction apparatus that lacks the function, to another multifunction apparatus that is equipped with the function.

### BRIEF DESCRIPTION OF THE DRAWINGS

The present invention is further described in the detailed description which follows, with reference to the noted plurality of drawings by way of non-limiting examples of exemplary embodiments of the present invention, in which like reference numerals represent similar parts throughout the several views of the drawings, and wherein:

FIG. 1 illustrates a system configuration of a server system according to the first and second embodiments of the present invention, with a focus on a configuration of a multifunction apparatus;

FIG. 2 illustrates a detailed system configuration of a server that is included in the server system according to the first and second embodiments of the present invention;

FIG. 3 is a flowchart illustrating generation of menu information according to the first embodiment of the present invention;

FIG. 4 illustrates menu display capability information of multifunction apparatuses;

FIG. 5 illustrates job capability information of multifunction apparatuses;

FIG. 6 illustrates a configuration of menu information;

FIG. 7 is a flowchart illustrating obtaining of menu information according to the first embodiment of the present invention;

FIG. 8 is a flowchart illustrating automatic obtaining of capability information according to the first embodiment of the present invention;

FIG. 9 is a flowchart illustrating a function combination according to the second embodiment of the present invention;

FIG. 10 illustrates menu information used in the second embodiment of the present invention; and

FIG. 11 illustrates distribution information used in the second embodiment of the present invention.

### DETAILED DESCRIPTION OF PREFERRED EMBODIMENTS

The embodiments of the present invention are explained in the following, in reference to the above-described drawings.

First Embodiment

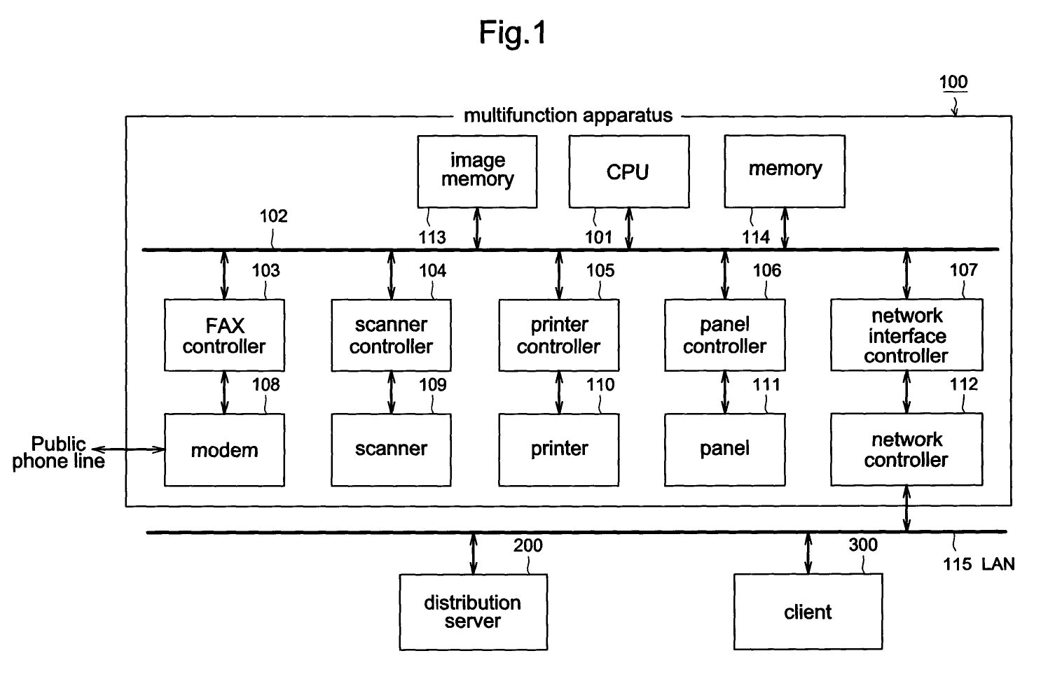

FIG. 1 illustrates a system configuration of a server system according to the embodiment of the present invention, with a focus on functional blocks of a multifunction apparatus. In multifunction apparatus 100 of FIG. 1, CPU 100 is connected to fax controller 103, scanner controller 104, printer controller 105, panel controller 105, and network interface controller 107, via internal bus 102. Fax controller 103 exchanges facsimile data by delivering image data from image memory 113, via modem 108. Scanner controller 104 controls scanner 109 for scanning a document, and stores image data in image memory 113. Printer controller 105 controls printer 110 to print the image data stored in image memory 113. Panel controller 106 reads menu information stored in memory 114 and displays on panel 111. Network interface controller 107 controls network controller 112 and exchanges data with distribution server 200 and client 300 on network 115.

In addition, a plurality of multifunction apparatuses, having similar configurations to multifunction apparatus 100, are connected to network 115. Distribution server 200 and client 300 can be configured at a computer. Although LAN is used as an example of network 115, WAN can be used as a network.

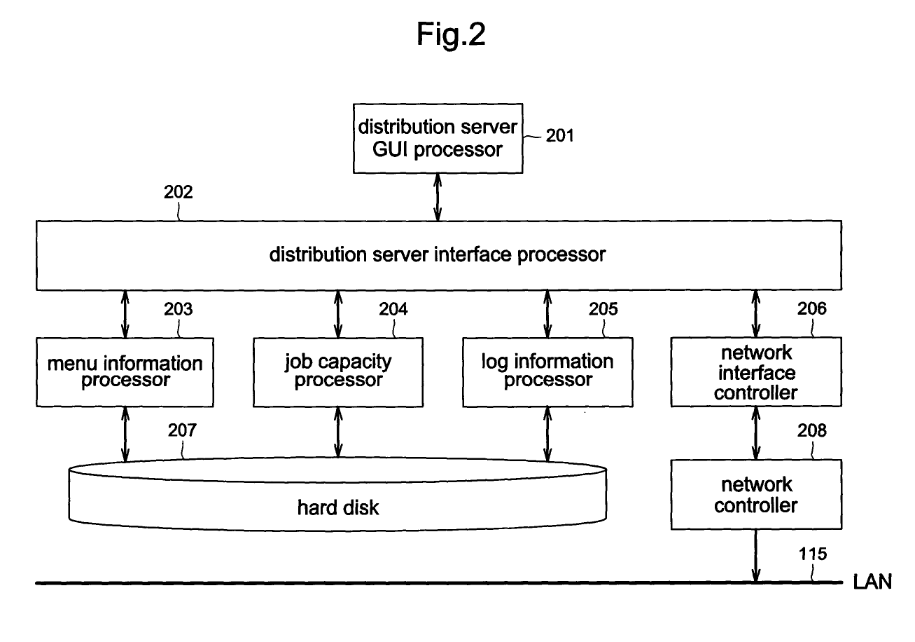

FIG. 2 is a functional block diagram illustrating distribution server 200. Distribution server GUI (Graphic User Interface) processor 201 of FIG. 2 performs GUI processes of distribution server 200, such as generating menu information for jobs to be executed by multifunction apparatus 100, displaying menu display capability information and job capability information of multifunction apparatus 100, and displaying log information. Distribution server GUI processor 201 is also connected to menu information processor 203, job capability processor 204, log information processor 205, and network interface controller 206, via distribution server interface processor 202.

Menu information processor 203 writes and reads menu information data in/from hard disk 207, the data being generated on a screen of distribution server GUI processor 201. Job capability processor 204 writes and reads job capability information data (copying, printing, scanning, fax transmission, etc.) in/from hard disk 207, the data being processed by multifunction apparatus 100 on network 115. Log information processor 205 writes and reads log information data in/from hard disk 207, the data being functions performed on distribution server 200. In addition, hard disk 207 stores menu information, job capability information, and log information in a multi-use data format, such as XML and CSL file format, so that the data has compatibility with other systems. Network interface controller 206 exchanges data, via network controller 208, with multifunction apparatus 100 and client 300 on network 115, other distribution servers, and other systems.

The following illustrates specific operations within the distribution server system with the above-described configuration.

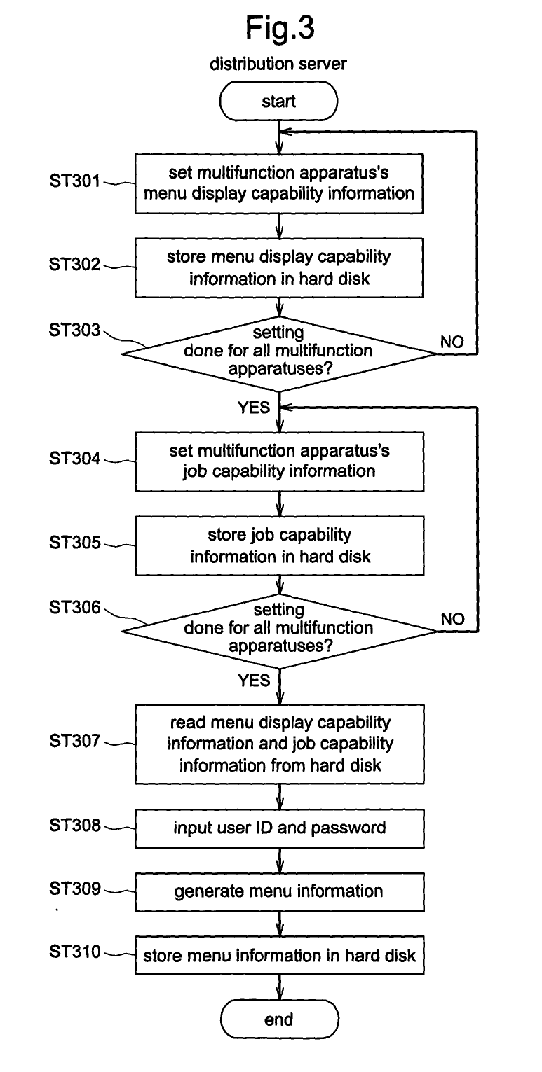

FIG. 3 is a flowchart illustrating that the distribution server 200 generates the menu information. First, a user sets menu display capability of the multifunction apparatus, via distribution server GUI processor 201 on distribution server 200 (ST 301). The menu display capability information, which is input via distribution server GUI processor 201, is stored in hard disk 207 (ST 302).

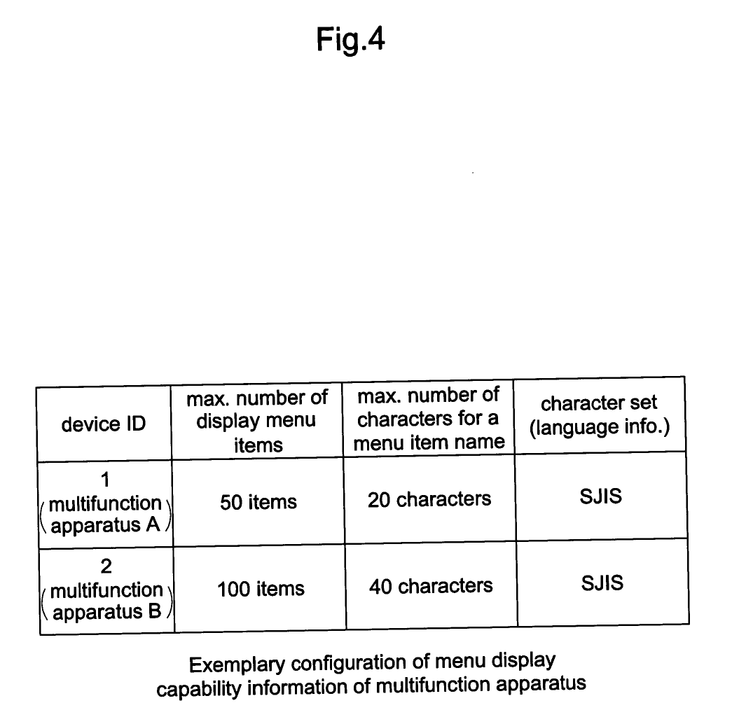

FIG. 4 illustrates an exemplary configuration of the menu display capability information of multifunction apparatuses. As shown in FIG. 4, the menu display capability information is registered for each multifunction apparatus, allowing the user to register data including device ID that identifies a multifunction apparatus, maximum number of display menu items, maximum number of characters for a menu item name, and character set. Other display capability information can be registered as long as it can be categorized as menu display capability information.

Accordingly, information relating to menu display capability for each multifunction apparatus is stored in hard disk 207 of distribution server 200. When it is complete to register the menu display capability information for all of the multifunction apparatuses (ST 303), the control moves to the next step for registering job capability information.

In the next step, the user sets job capability information for each multifunction apparatus, via distribution server GUI processor 201 (ST 304). Such job capability information for each multifunction apparatus (input via distribution server GUI processor 201) is stored in hard disk 207 (ST 305).

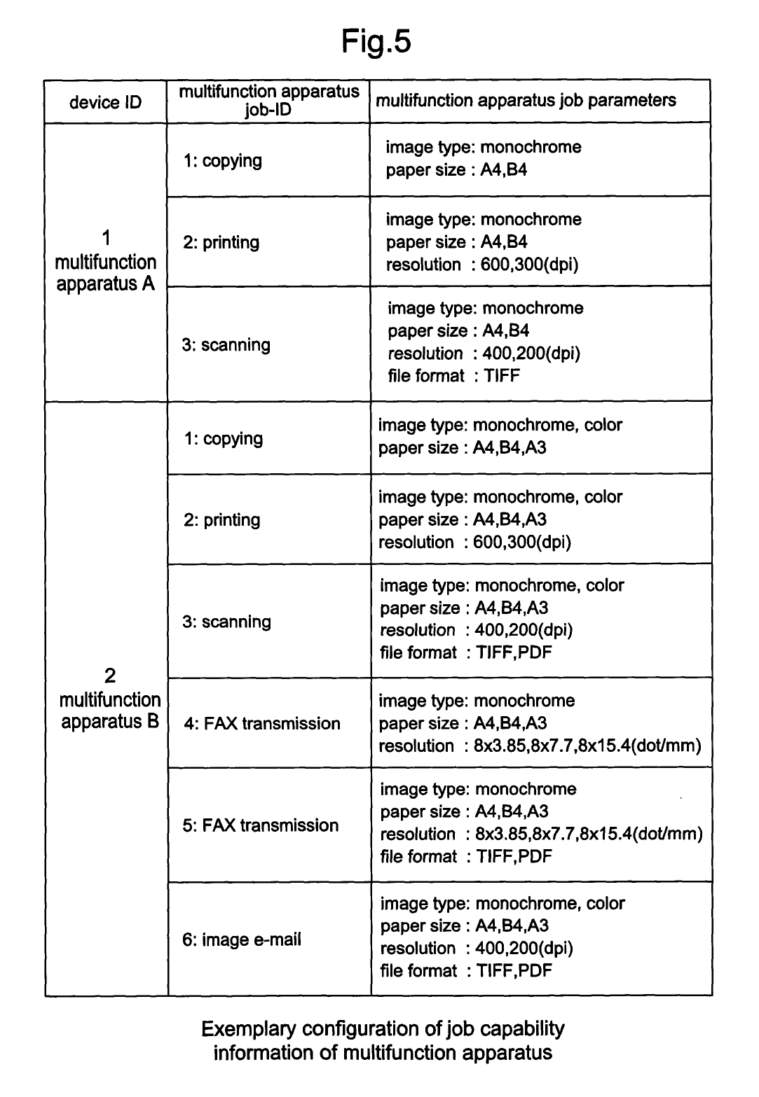

FIG. 5 illustrates an exemplary configuration of the job capability information of multifunction apparatuses. As shown in the FIG. 5, the job capability information is registered for each multifunction apparatus, including a job ID identifying each job that can be processed (e.g., copying, printing, and scanning), and job parameters having detail information for each job (e.g., copying image type and paper size).

Accordingly, the job capability information for each multifunction apparatus is stored in hard disk 207 of distribution server 200. When it is complete to register the job capability information for all of the multifunction apparatuses (ST 306), the control moves to the next step for registering menu information.

The following step generates customized menu information. Distribution server GUI processor 201 retrieves the menu display capability information and job capability information for each multifunction apparatus stored in hard disk 207, and displays on the display (ST 307).

A user who wants to create customized menu information first inputs a personal user ID and a password (ST 308). Then, by referring to the displayed menu display capability information and job capability information, the user determines a menu item (menu item name) to be performed on the multifunction apparatus, and selects the job ID for the menu item and the job parameters to be used, via distribution server GUI processor 201. A plurality of menu items can be registered.

When the user creates menu information including menu item name, job ID, and job parameters (input via distribution server GUI processor 201) (ST 309), the information is stored in hard disk 207 by giving a menu ID to each menu item name (ST 310). In particular, menu information registered by an individual is managed under his/her user ID, and a plurality of menu IDs can be registered under such user ID. In this example, distribution server GUI processor 201 functions as the menu generator.

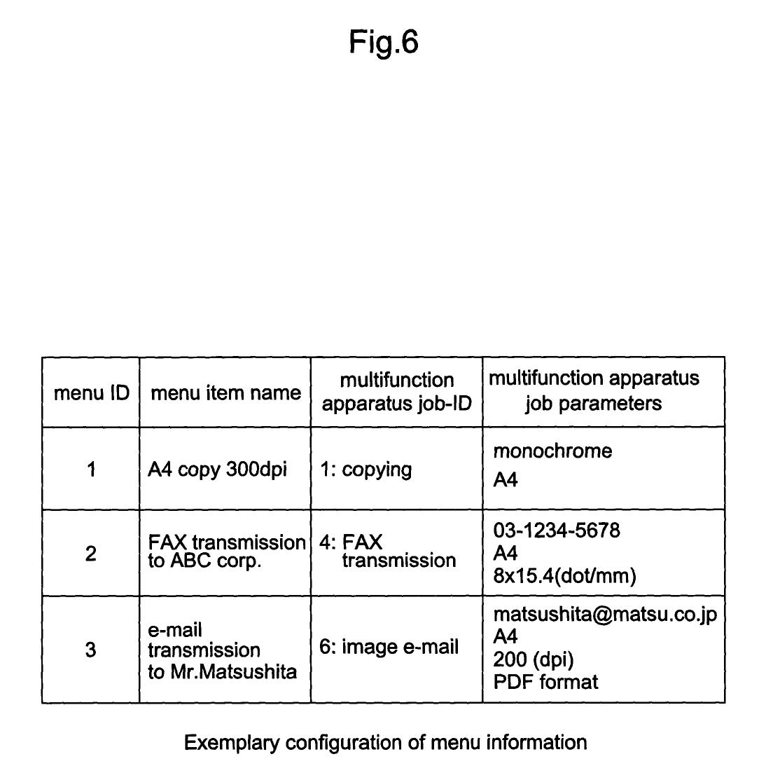

FIG. 6 illustrates an exemplary configuration of the menu information. As shown in FIG. 6, in order to register a menu item that uses a copying function with A4 size paper at 300 dpi resolution at a multifunction apparatus, the user can input a menu item name as “A4 copy 300 dpi”, job ID as “copying”, and job parameters as “monochrome, A4”. Upon registering the menu item name, the menu item name must be decided by referring to the menu display capability information, due to the limitation on the number of characters of the multifunction apparatus. In addition, the job capability information is referred to when the user inputs/selects the job and job parameters to be processed.

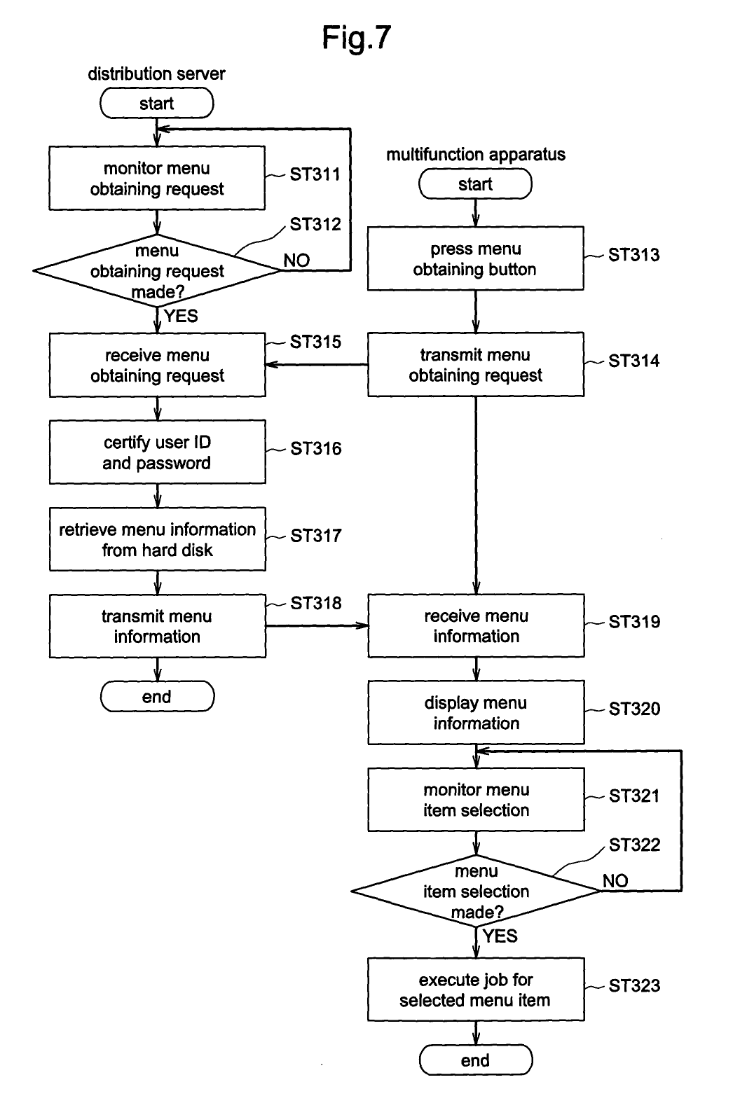

The flowchart in FIG. 7 is used to illustrate a situation where multifunction apparatus 100 executes a job by obtaining menu information from distribution server 200.

When menu information is needed, the user presses a menu obtaining key on panel 111 of multifunction apparatus 100. When the menu obtaining key is pressed, panel controller 106 detects the key being pressed (ST 313) and makes a request to distribution server 200 for the menu information, from network controller 112 via network interface controller 107 (ST 314). Upon requesting to obtain the menu information, the user ID and password are also transmitted.

Distribution server 200 monitors whether the menu information obtaining request is received at network interface controller 206, via network controller 208 (ST 311 and ST 312). When it is determined that the menu information obtaining request is made at ST 312 (ST 315) and when the user ID and password from multifunction apparatus 100 are found during the reception of the menu information obtaining request, the user ID and password are certified (ST 316). Then, menu information processor 203 retrieves the menu information corresponding to the user ID, from the menu information stored in hard disk 207, via distribution server interface processor 202 (ST 317). In other words, the menu IDs have already been registered corresponding to the user ID. The all menu IDs are picked up based on the user ID. The corresponding menu information is retrieved based on each menu ID.

Then, network interface controller 206 transmits menu information to multifunction apparatus 100, via distribution server interface processor 202, as a response to the menu information request (ST 318).

Upon receiving the menu information (ST 319), multifunction apparatus 100 enables panel controller 106 to display menu information on panel 111 (ST 320). When the user selects one of the menu items displayed on panel 111 of multifunction apparatus 100 (ST 321 and ST 322), multifunction apparatus 100 executes the job according to the defined job ID with defined job parameters of the menu information (ST 323).

Accordingly, on the distribution server system according to the present embodiment, menu information generated on distribution server 200 can be submitted to one multifunction apparatus on network 115. Therefore, menu information regarding a customized operation can be chosen at another multifunction apparatuses, in order to execute the user's original job.

Further, according to the distribution server system of the present embodiment, menu information stored in hard disk 207 of distribution server 200 is managed by a multi-use data format (e.g., XML and CSV files) for the data compatibility with other systems on network 115. Thus, the menu information can be easily shared and exchanged among a plurality of systems.

Additionally, according to the distribution server system of the present embodiment, distribution server 200 generates and stores menu information based on the menu display capability and job capability information, which varies among multifunction apparatuses. Further, menu information is managed with user ID, in order to allow menu information to be generated for each individual. The menu information corresponding to the user ID is obtained by inputting the user ID and its password from panel 111 of multifunction apparatus 100. Therefore, the menu information for each user can be obtained by various multifunction apparatuses on network 115, and be viewed according to the need of each user.

Moreover, according to the distribution server system of the present embodiment, menu information is relates to an operation customized for a particular user. However, menu information can relate to information that is commonly utilized for the multifunction apparatus and for another multifunction apparatus. Menu information can also relate to whole information regarding menu that is utilized only for the multifunction apparatus. Menu information includes any other information regarding menu.

In the above illustration, the user inputs menu display capability information and job capability information for each multifunction apparatus, into distribution server 200. However, the system can be configured so as to enable distribution server 200 to automatically collect the capability information via the network.

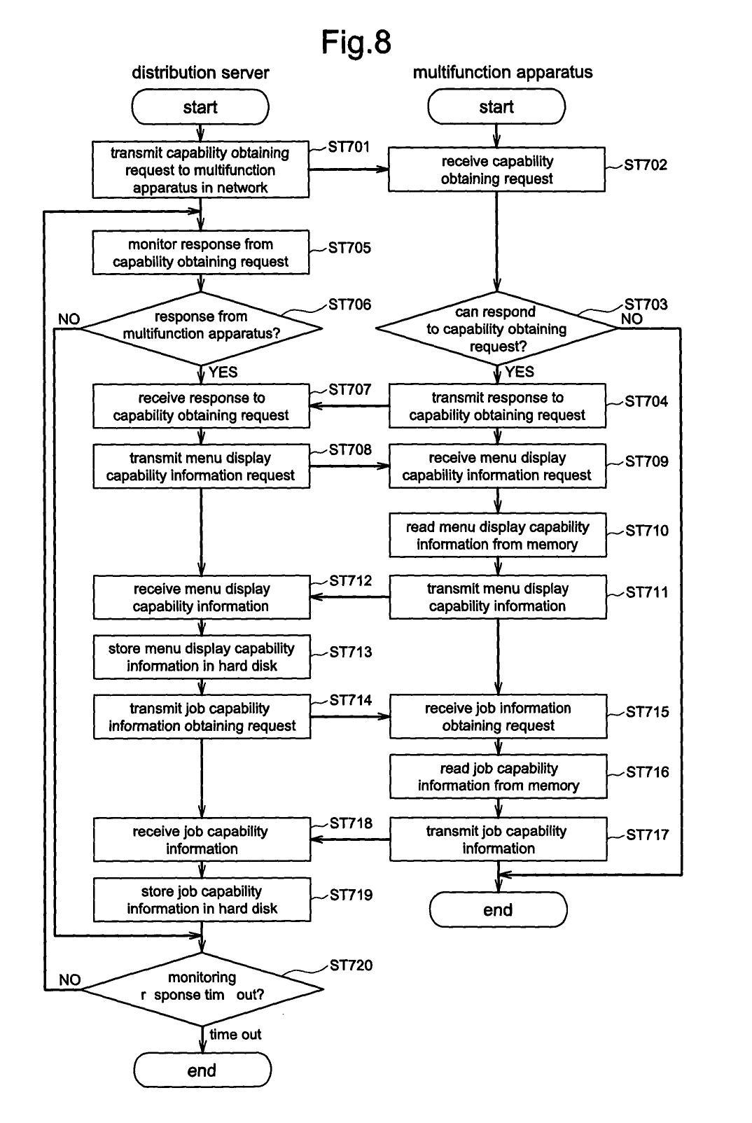

FIG. 8 is a flowchart illustrating an automatic obtaining of menu display capability information and job capability information from a multifunction apparatus, on a distribution server of a distribution server system.

When a search key of distribution server GUI processor 201 is pressed at distribution server 200, a request for obtaining capability information is broadcasted to all multifunction apparatuses on network 115, via network interface controller 206 (ST 701). For example, multifunction apparatuses on network 115 are searched using protocols such as MIB and SOAP.

The multifunction apparatus shown in FIG. 8 is multifunction apparatus 100 on network 115. Multifunction apparatus 100 receives the request for obtaining capability information from distribution server 200 (ST 702). When multifunction apparatus 100 has the ability to respond to the request of obtaining capability information (ST 703), a response to the request is transmitted (ST 704).

After transmitting the request to obtain capability information at ST 701, distribution server 200 monitors the response to the request (ST 705). When there is a response from the multifunction apparatus, the response to the request is obtained (ST 706 and ST 707). Then, distribution server 200 makes a request to the responded multifunction apparatus for its menu display capability information (ST 708).

When the multifunction apparatus receives the request for the menu display capability information from distribution server 200 (ST 709), the multifunction apparatus reads its menu display capability information from memory 114 (ST 710), and transmits the read menu display capability information to distribution server 200 (ST 711).

Upon receiving the menu display capability information from the multifunction apparatus (ST 712), distribution server 200 stores the information in relation to the name of the multifunction apparatus in hard disk 207 (ST 713).

Next, distribution server 200 makes a request to the multifunction apparatus, from which the menu display capability information is obtained, for its job capability information (ST 714).

Upon receiving the request for the job capability information from distribution server 200 (ST 715), the multifunction apparatus reads its job capability information from memory 114 (ST 716) and transmits the read information to distribution server 200 (ST 717).

Upon receiving the job capability information from the multifunction apparatus (ST 718), distribution server 200 stores the information in relation to the name of the multifunction apparatus in hard disk 207 (ST 719).

While distribution server 200 monitors the response from the multifunction apparatus at ST 706 and timeout occurs without getting a response (ST 720), the process is ended.

As described above, multifunction apparatuses on network 115 are searched using a plurality of multi-use communication methods (such as MIB and SOAP) for automatically obtaining menu display capability information and job capability information for each multifunction apparatus. Therefore, the multifunction apparatuses on network 115 are automatically searched when menu information is generated on distribution server 200. In addition, multifunction apparatus information such as menu display capability, job capability, and IP address can be automatically obtained without manually entering the information on distribution server 200.

Second Embodiment

The following describes a server system according to the second embodiment of the present invention. Since the system configuration of the server system is the same as the first embodiment, the same numerical characters from FIGS. 1 and 2 are applied.

When menu information is selected on multifunction apparatus A, the present invention enables an execution of a desired job by combining functions of multifunction apparatus B to supplement the functions that multifunction apparatus A does not have.

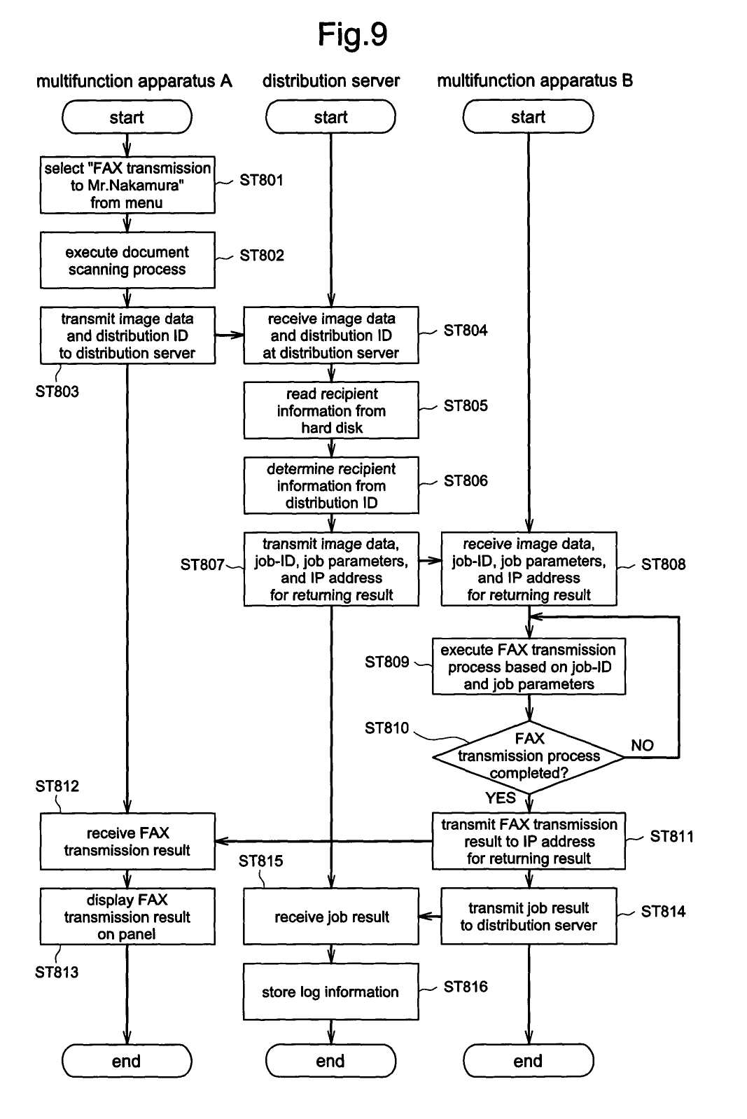

FIG. 9 is a flowchart illustrating an execution of a job in menu information by combining functions of multifunction apparatuses A and B, using the menu information of multifunction apparatus A generated on distribution server 200. In this embodiment, multifunction apparatuses A and B have the same functions as multifunction apparatus 100 of FIG. 1, except multifunction apparatus A is equipped with scanner, printer, and copier functions but not a facsimile function (all of configuration of FIG. 1 but the facsimile function), and multifunction apparatus B is equipped with scanner, printer, copier and facsimile functions.

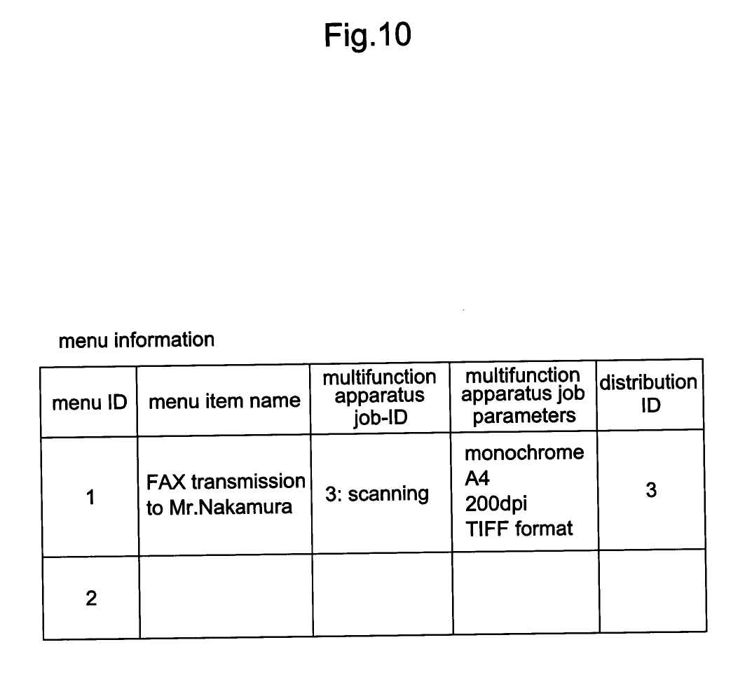

FIG. 10 illustrates menu information customized for a particular user, relating to multifunction apparatus A, stored in distribution server 200. FIG. 10 illustrates an exemplary configuration of menu information relating to multifunction apparatus A. As shown in FIG. 10, menu ID “1” has “fax transmission to Mr. Nakamura” registered as a job under the menu item name. However, multifunction apparatus A does not have a facsimile function as previously described.

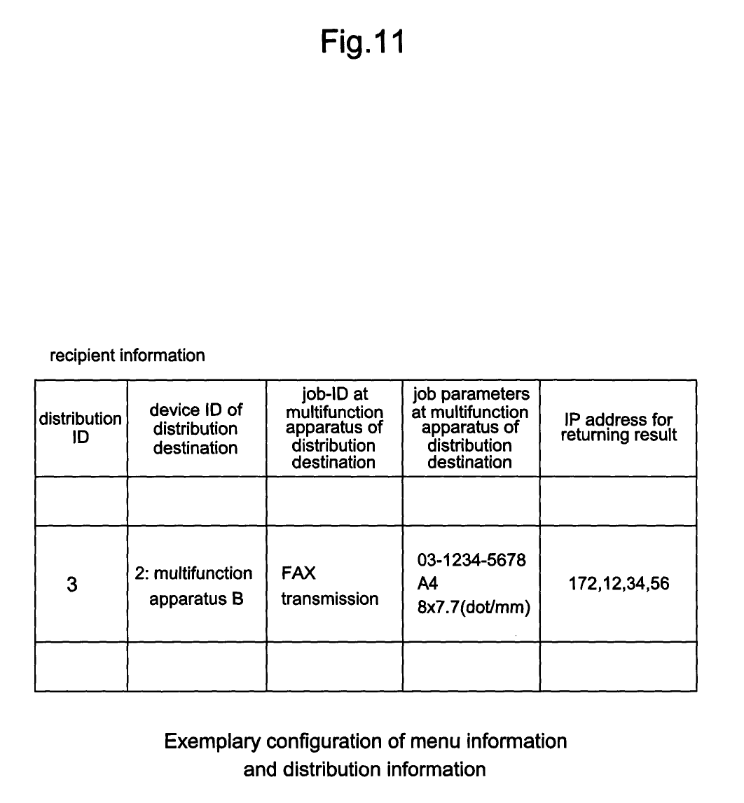

Therefore, “distribution ID” is newly added to the menu information (link information), so that the each menu item is linked to recipient information. FIG. 11 illustrates an exemplary configuration of the recipient information that is linked to “fax transmission to Mr. Nakamura”. As shown in FIG. 11, recipient information includes “distribution ID” that links itself to a specific menu item within menu information, “device ID” shows device ID information at the distribution destination, “job ID” that indicates job to be executed at the multifunction apparatus of the distribution destination, “job parameters” that indicate a job specification at the multifunction apparatus of the distribution destination, and “IP address” that specifies an address where the job execution result should be notified. The items for distribution information are not limited to the above example. Other arbitrary item combinations can also be programmed.

The menu information and recipient information is preprogrammed and stored in hard disk 207 of distribution server 200.

The following illustration uses a situation where, in the distribution server system of the above configuration, multifunction apparatus A which does not have a facsimile function uses a menu item for a fax transmission. The fax is transmitted from multifunction apparatus B.

Similar to the first embodiment of the present invention, the user operates multifunction apparatus A to obtain a menu from distribution server 200. The menu is customized for the operation of the user. Then, menu information is displayed on panel 113 of multifunction apparatus A. The displayed menu information includes “fax transmission to Mr. Nakamura” at menu ID=1.

When “fax transmission to Mr. Nakamura” is selected from the menu at multifunction apparatus A (ST 801), multifunction apparatus A scans the document based on multifunction apparatus job ID (“scanning”) and multifunction apparatus job parameters (“monochrome, A4, 200 dpi”) from the menu information (ST 802). Then, the image data scanned at multifunction apparatus A and distribution ID (“distribution ID=3”, corresponding to “fax transmission to Mr. Nakamura” of menu ID=1) are transmitted to distribution server 200 (ST 803).

Upon receiving the image data and distribution ID (ST 804), distribution server 200 reads recipient information from hard disk 207 (ST 805). Based on the distribution ID, recipient information is specified (ST 806). Distribution server 200 recognizes a multifunction apparatus of the distribution destination from the distribution device ID with the specified recipient information, and obtains job ID of the multifunction apparatus of the distribution destination, job parameters for the job, and IP address of the return address for the result. Then, the obtained recipient information and the received image data are transmitted to multifunction apparatus B, which is recognized as the distribution destination (ST 807). Multifunction apparatus B has a facsimile function. In particular, using the example of FIG. 11, information including “fax transmission” (job ID of multifunction apparatus B of the distribution destination (distribution ID=3)), “03-1234-5678, A4, fine” (job parameters of the multifunction apparatus of the distribution destination), and “172. 12. 34. 56(multifunction apparatus A)” (the return IP address for the result) are transmitted together with the image data.

Multifunction apparatus B receives the image data, job ID (for the multifunction apparatus of the distribution destination), job parameters (for the multifunction apparatus of the distribution destination), and the return IP address for the result, from distribution server 200 (ST 808). Based on the received image data, job ID (for the multifunction apparatus of the distribution destination), and job parameters (for the multifunction apparatus of the distribution destination), multifunction apparatus B executes a facsimile transmission to fax number “03-1234-5678”, with “A4” size and “fine” resolution (ST 809). When the facsimile transmission is complete (ST 810), multifunction apparatus B transmits the result of the facsimile transmission to the return IP address (ST 811).

Since multifunction apparatus A is the return address for the result, multifunction apparatus A receives the result of the facsimile transmission (ST 812), and displays the result on the panel (ST 813).

Multifunction apparatus B also transmits the job result to distribution server 200 (ST 814). Upon receiving the job result (ST 815), distribution server 200 stores the job result as functional log information in hard disk 207, and manages the information in a multi-use data format (e.g., XML) for data compatibility with other systems. When there is a request from another system, such log information can be transmitted to the requesting system.

According to the second embodiment of the present invention, when a menu information is selected from a list of job menu items on multifunction apparatus A, and when multifunction apparatus A does not have the function to perform the selected job, the job is performed by combining the functions of multifunction apparatuses A and B via distribution server 200, multifunction apparatus B having the necessary function.

In addition, the second embodiment of the present invention, upon combining the functions of multifunction apparatuses A and B, specifies return addresses such as IP addresses of multifunction apparatus A and distribution server 200, to which the result of the job performance of multifunction apparatus B is transmitted. Therefore, when the transmitting document is scanned at multifunction apparatus A and the fax transmission job is distributed to multifunction apparatus B, multifunction apparatus B can notify the specified return address about the facsimile transmission. Therefore, the user can freely set the return address for the result at a multifunction apparatus, distribution server, or a PC, so that the result can be checked from the desired location.

Furthermore, according to the second embodiment of the present invention, the executed job is stored as log information on distribution server 200, in a multi-use data format (e.g., XML) for data compatibility with other systems on network 115. Therefore, such log information can be exchanged and shared in an XML format among other systems.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above-described embodiments, and various variations and modifications may be possible without departing from the scope of the present invention.

This application is based on the Japanese Patent Application No. 2002-281283 filed on Sep. 26, 2003, entire content of which is expressly incorporated by reference herein.

What is claimed is:

1. A multifunction apparatus having at least a copying function, connecting with a server via a network, the apparatus comprising;
a panel configured to display a menu representing functions of the multifunction apparatus;
a controller configured to communicate with the server, to receive information regarding the menu from the sever, and to have the menu displayed on the panel based on the information regarding the menu.

2. The multifunction apparatus according to claim 1, wherein the information regarding the menu is commonly utilized for the multifunction apparatus and for another multifunction apparatus.

3. The multifunction apparatus according to claim 1, wherein the information regarding the menu is utilized only for the multifunction apparatus.

4. The multifunction apparatus according to claim 1, wherein the information regarding the menu is utilized for at least one of a plurality of functions of the multifunction apparatus.

5. The multifunction apparatus according to claim 4, wherein at least one of a plurality of functions of the multifunction apparatus is an operation customized for a particular user.

6. The multifunction apparatus according to claim 1, wherein the information regarding the menu contains a menu item name, the menu item name indicating a job that the multifunction apparatus performs.

7. The multifunction apparatus according to claim 1, wherein the information regarding the menu contains a menu item name, a job-ID and a job parameter.

8. The multifunction apparatus according to claim 7, wherein the multifunction apparatus additionally has at least one of a scanning, printing, and a facsimile transmission function and the job ID includes at least one of copying, printing, scanning and fax transmission.

9. The multifunction apparatus according to claim 7, wherein the job parameter includes at least one of an image type and paper size for copying.

10. The multifunction apparatus according to claim 7, wherein the job parameter includes at least one of an image type, paper size and resolution for printing.

11. The multifunction apparatus according to claim 7, wherein the job parameter includes at least one of an image type, paper size, resolution and file format for scanning.

12. The multifunction apparatus according to claim 7, wherein the job parameter includes at least one of an image type, paper size, resolution and file format for facsimile transmission.

13. A multifunction apparatus having at least a copying function, connected with a server via a network, the apparatus comprising;
a panel configured to display a menu representing functions of the apparatus;
a key configured to obtain information regarding a menu from the server;
a controller configured to communicate with the server, to receive the information regarding the menu from the server, and to have the menu displayed on the panel based on the information regarding the menu, when the key is pressed.

14. A multifunction apparatus having at least a function of a copier, connecting with a server via a network, the apparatus comprising;
a panel configured to display a menu representing functions of the apparatus;
a key configured to input user ID;
a controller configured to communicate with the server, to receive information regarding a menu corresponding to the user ID from the sever, and to have the menu corresponding to the user ID displayed on the panel based on the information regarding the menu.

15. A server connecting with a multifunction apparatus via a network, the server comprising;
a communicator configured to communicate with the multifunction apparatus via the network;
a controller configured to send a signal to the multifunction apparatus for obtaining information regarding a menu that is displayed on a panel of the multifunction apparatus, to obtain the information regarding the menu from the multifunction apparatus, and to store the information in a memory.

16. The server according to claim 15, wherein, the information regarding the menu contains information regarding a maximum number of characters that can displayed on the display of the multifunction apparatus.

17. The server according to claim 15, wherein the information regarding the menu contains information regarding capabilities of the multifunction apparatus.

18. The server according to claim 15, wherein the controller being further configured to transmit the information stored in the memory to the panel of the multifunction apparatus distinct from the multifunction apparatus from which the information was obtained.

19. A server connecting with a multifunction apparatus via a network, the server comprising;
a key configured to send a signal for obtaining information regarding a menu from the multifunction apparatuses;
a communicator configured to communicate with the multifunction apparatus via the network;
a controller configured to send a signal to the multifunction apparatus for obtaining information regarding the menu that is displayed on a panel of the multifunction apparatus, to obtain the information regarding the menu from the multifunction apparatus, and to store the information in a memory, when the key is pressed.

20. A server connecting a plurality of multifunction apparatuses via a network comprising;
a communicator configured to communicate with a plurality of the multifunction apparatuses via the network;
a controller configured to send the signal for obtaining information regarding menus to all of a plurality of the multifunction apparatus, to obtain the information regarding the menus from all of a plurality of the multifunction apparatuses, and to store the information regarding the menus in a memory.

21. A server connecting a plurality of multifunction apparatuses via a network comprising;
a key configured to send a signal for obtaining information regarding menus from all of a plurality of multifunction apparatuses;
a communicator configured to communicate with a plurality of the multifunction apparatuses via the network;
a controller configured to send the signal to all of a plurality of the multifunction apparatus when a key is pressed, to obtain the information regarding the menus from all of a plurality of the multifunction apparatuses, and to store the information regarding the menus in a memory.

22. A server connecting a multifunction apparatus via a network comprising;
a memory configured to store information regarding a menu that is displayed on a panel of the multifunction apparatus;
a communicator configured to communicate with the multifunction apparatus via the network;
a controller configured to receive a signal from the multifunction apparatus requesting the information regarding a menu, and to transmit the information regarding the menu to the multifunction apparatus.

23. The server according to claim 22, wherein the information regarding the menu is formed based on first information regarding a maximum number of characters that can be displayed on the panel of the multifunction apparatus and second information regarding capabilities of the multifunction apparatus.

24. A server connecting a plurality of multifunction apparatuses via a network comprising;
a memory configured to store information regarding menus of a plurality of the multifunction apparatuses;
a communicator configured to communicate with the multifunction apparatus via the network;
a controller configured to receive a signal requesting the information regarding a menu with together user ID from the multifunction apparatus, to search the memory for the information regarding the menu corresponding to user ID, and to transmit the information regarding the menu to the multifunction apparatus in association with the user ID.

25. A server connecting a plurality of multifunction apparatuses via a network comprising;
a memory configured to store a recipient information that is utilized for having image data from a multifunction apparatus transmitted to a recipient;
a communicator configured to communicate with a plurality of multifunction apparatuses via the network;
a controller configured to receive image data from a first multifunction apparatus which can not perform a facsimile transmission, and to send the image data with together the recipient information to a second multifunction apparatus which can perform a facsimile transmission, and to have the second multifunction apparatus transmitted the image data to the recipient via a public phone line based on the recipient information.

26. The server according to claim 25, wherein the recipient information includes a fax number of the recipient.

27. The server according to claim 25, wherein the recipient information includes an IP address of the first multifunction apparatus, the second multifunction apparatus utilizing the IP address sent a result of a facsimile transmission to the first multifunction apparatus.

28. A multifunction apparatus having at least a scanning function and not having a facsimile transmission function, the multifunction apparatus connected with a server via a network, the multifunction apparatus comprising;
a scanner configured to scan a document;
a panel configured to display a menu representing functions of the multifunction apparatus;
a controller configured to communicate with the server, to receive information regarding a menu from the sever, and to have a menu displayed on the panel based on the information regarding the menu; and
said controller configures to send, to the server, a scanned image data with together information indicating a multifunction apparatus which can transmit the image data to a recipient, when a menu indicating a facsimile transmission function is displayed on the panel, based on the information regarding the menu, and a facsimile transmission is selected on the menu.

29. The multifunction apparatus according to claim 28, wherein the controller utilizes a scanning function to scan a document, when the facsimile transmission is selected on the menu.

30. A server system including a server and a multifunction apparatus connecting with each other via network comprising;
the server comprising;
a communicator configured to communicate with the multifunction apparatus via the network;
a controller configured to send a signal for obtaining information regarding a menu that is displayed on a panel of the multifunction apparatus, and to obtain the information regarding the menu from the multifunction apparatus;
the multifunction apparatus comprising;
a panel configured to display a menu representing functions of the apparatus;
a controller configured to communicate with the server, to receive information regarding the menu from the sever, and to have the menu displayed on the panel based on the information regarding the menu.

31. A method for controlling a multifunction apparatus having at least copying function, the multifunction apparatus connecting a server via a network, the multifunction apparatus having a panel that displays a menu representing functions of the multifunction apparatus, the method comprising;
communicating with the server;
receiving information regarding the menu from the sever; and
having the menu displayed on the panel based on the information regarding the menu.

32. The method according to claim 31, wherein the information regarding the menu is commonly utilized for the multifunction apparatus and for another multifunction apparatus.

33. The method according to claim 31, wherein the information regarding the menu is utilized only for the multifunction apparatus.

34. The method according to claim 31, wherein the information regarding the menu is utilized for at least one of a plurality of functions of the multifunction apparatus.

35. The method according to claim 34, wherein at least one of a plurality of functions of the multifunction apparatus is an operation customized for a particular user.
